(19) United States
(12) Patent Application Publication
(10) Pub. No.: US 2025/0342424 A1
(43) Pub. Date: Nov. 6, 2025

(54) MACHINE LEARNING (ML) MODEL BASED PREDICTION OF DELAYS IN WORKFLOWS

(71) Applicant: Oracle International Corporation, Redwood Shores, CA (US)

(72) Inventors: Girish R. Rao, Bengaluru (IN); Karthi Vijayakumaar, Coimbatore (IN); Padmakumar Nambiar, Bengaluru (IN)

(21) Appl. No.: 18/768,132

(22) Filed: Jul. 10, 2024

(30) Foreign Application Priority Data
May 3, 2024 (IN) 202441035254

(51) Int. Cl. G06Q 10/0633; G06Q 10/0631

(52) U.S. Cl. CPC G06Q 10/0633; G06Q 10/063114; G06Q 10/06312

(57) ABSTRACT

According to an aspect, a system collects historical data indicating details of multiple closed workflows and trains an ML model based on the multiple closed workflows, the ML model thereafter operable to predict delays for open workflows. Upon receiving, after the training, details of an additional set of closed workflows, the system adds the received details to the historical data to form an updated historical data. The system checks whether the updated historical data has a data growth (in comparison to the historical data) exceeding a threshold. If the data growth exceeds the threshold, the system determines whether there exists a data drift in the updated historical data in comparison to the historical data. If the data drift exists, the system retrains the ML model based on the updated historical data, wherein the retrained ML model is thereafter operable to predict delays for open workflows.

### PRIORITY CLAIM

The instant patent application is related to and claims priority from the co-pending India provisional patent application entitled, “RELIABLE ACCURATE PREDICTION OF WORKFLOW DELAYS IN CONSTRUCTION AND ENGINEERING PROJECTS”, Serial No.: 202441035254, Filed: 3 May 2024, which is incorporated in its entirety herewith.

### BACKGROUND OF THE DISCLOSURE

### Technical Field

The present disclosure relates to machine learning (ML) systems and more specifically to machine learning (ML) model based prediction of delays in workflows.

### Related Art

Workflow refers to a set of actions that are to be performed to process data through a specific path from initiation to completion. For example, a document review workflow refers to the creation, review, and approval/rejection (path) of one or more documents (data). Each action typically specifies one or more tasks, the person(s) allocated to perform each task, and a time allocated for the completion of each task.

Delays in workflows are often encountered due to various reasons such as non-completion of a task/action within the allocated time, a task/action requiring time more than the time allocated, etc. As may be readily appreciated, such delays are not desirable and accordingly knowing these delays ahead of time enables the person(s) to pro-actively take corrective actions (e.g., reschedule the tasks, change the tasks, etc.).

Prediction of delays refers to usage of past historical data containing the details of completed workflows and associated actual delays to determine a delay for a current workflow (that is open/being performed). By correlation of the actions in the completed workflows to the actions in the current workflow, the delay for the current workflow may be predicted/determined.

Machine Learning (ML) models are commonly employed for performance of such correlation as is well known in the arts. ML models typically use ML approaches such as KNN (K Nearest Neighbor), Decision Tree, etc. for the correlation of historical data and the prediction of delays.

Aspects of the present disclosure are directed to providing ML model based prediction of delays in workflows.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present disclosure can be implemented.

FIG. 2 is a flow chart illustrating the manner in which a machine learning (ML) model based prediction of delays in workflows is provided according to aspects of the present disclosure.

FIG. 3 is a block diagram depicting an implementation of a predictor tool in one embodiment.

FIG. 4A depicts a portion of the features used to train ML models operative to predict delays in workflows in one embodiment.

FIG. 4B depicts the details of the open and closed workflows in one embodiment.

FIG. 4C depicts the delays predicted before and after retraining of ML model in one embodiment.

FIG. 5 is a block diagram illustrating the details of a digital processing system in which various aspects of the present disclosure are operative by execution of appropriate

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure provides machine learning (ML) model based prediction of delays in workflows. In one embodiment, a digital processing system collects a historical data indicating details of multiple closed workflows and trains an ML model based on the multiple closed workflows, the ML model thereafter operable to predict delays for open workflows. Upon receiving, after the training, details of an additional set of closed workflows, the system adds the details of the additional set of closed workflows to the historical data to form an updated historical data. The system checks whether the updated historical data has a data growth exceeding a threshold, the data growth being calculated in comparison to the historical data. If the data growth exceeds the threshold, the system determines whether there exists a data drift in the updated historical data in comparison to the historical data. If the data drift exists, the system retrains the ML model based on the updated historical data, wherein the retrained ML model is thereafter operable to predict delays for open workflows.

According to another aspect of the present disclosure, the checking and the determining are performed at a first time instance. if a first data growth calculated at the first time instance does not exceed the threshold or if the first data growth exceeds the threshold but a first data drift is determined to not exist at the first time instance, the system (noted above) continues to use the ML model trained or retrained at a previous time instance prior to the first time instance.

According to one more aspect of the present disclosure, for retraining (noted above), the system trains a new ML model based on the multiple closed workflows and the additional set of closed workflows and then replaces the (previous) ML model with the new ML model such that the new ML model is thereafter operable to predict delays for open workflows. The actions of receiving and adding, checking, determining, and retraining (all noted above) are performed at multiple time instances including the previous time instance to keep the ML model adapted to changes in the historical data such that delays for open workflows continue to be predicted accurately.

According to yet another aspect of the present disclosure, for the checking at the first time instance, the system calculates the first data growth as (current data size-previous data size)/previous data size, where the current data size and the previous data size are amounts of the updated historical data at the first time instance and the previous time instance respectively.

According to an aspect of the present disclosure, for the determining the first data drift at the first time instance, the system employs multiple statistical approaches to identify a corresponding shift in data of the updated historical data at the first time instance in comparison to the updated historical data at the previous time instance, each statistical approach providing a respective result indicating the corresponding shift in data. The system then detects the first data drift based on the respective results provided by the multiple statistical approaches.

According to another aspect of the present disclosure, the multiple statistical approaches include a Population Stability Index (PSI) test and a binary classification test. The system detects that the first data drift exists only if all of the respective results (noted above) indicate the corresponding shift in data.

According to one more aspect of the present disclosure, each workflow comprises one or more workflow steps, where details of a workflow step in a closed workflow includes a flag to indicate whether the workflow step is to be performed in serial or in parallel, a type of the document to be reviewed in the workflow step, a total number of organizations involved in the workflow step, an expected time assigned for completion of the workflow step, an organization performance indicating an efficiency of an assigned organization in a previous number of days, an organization load indicating a total count of active tasks pending a response from the assigned organization and an actual delay indicating the difference between a total number of days in which the workflow step was completed and the expected time.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

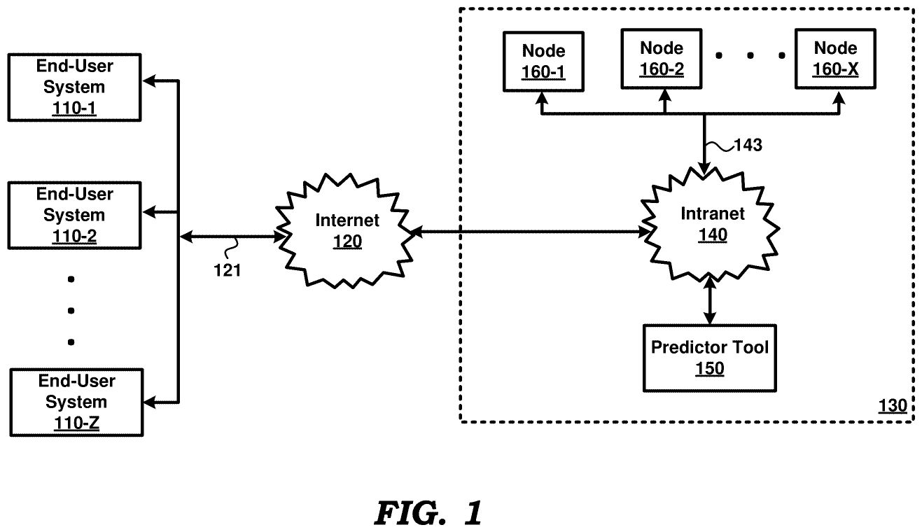

FIG. 1 is a block diagram illustrating an example environment (computing system) in which several aspects of the present disclosure can be implemented. The block diagram is shown containing end-user systems 110-1 through 110-Z (Z representing any natural number), Internet 120, and computing infrastructure 130. Computing infrastructure 130 in turn is shown containing intranet 140, nodes 160-1 through 160-X (X representing any natural number), and predictor tool 150. The end-user systems and nodes are collectively referred to by 110 and 160 respectively.

Merely for illustration, only representative number/type of systems are shown in FIG. 1. Many environments often contain many more systems, both in number and type, depending on the purpose for which the environment is designed. Each block of FIG. 1 is described below in further detail.

Computing infrastructure 130 is a collection of nodes (160) that may include processing nodes, connectivity infrastructure, data storages, administration systems, etc., which are engineered to together host software applications. Computing infrastructure 130 may be a cloud infrastructure (such as Amazon Web Services (AWS) available from Amazon.com, Inc., Google Cloud Platform (GCP) available from Google LLC, etc.) that provides a virtual computing infrastructure for various customers, with the scale of such computing infrastructure being specified often on demand.

Alternatively, computing infrastructure 130 may correspond to an enterprise system (or a part thereof) on the premises of the customers (and accordingly referred to as “On-prem” infrastructure). Computing infrastructure 130 may also be a “hybrid” infrastructure containing some nodes of a cloud infrastructure and other nodes of an on-prem enterprise system.

All of nodes 160 and other systems in computing infrastructure 130 (such as predictor tool 150) are connected via intranet 140. Internet 120 extends the connectivity of these (and other systems of the computing infrastructure) with external systems such as end-user systems 110. Each of intranet 140 and Internet 120 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by Internet 120 and intranet 140. When the packet contains content such as port numbers, which specifies a target application, the packet may be said to be directed to such application as well.

Some of nodes 160 may be implemented as corresponding data stores. Each data store represents a non-volatile (persistent) storage facilitating storage and retrieval of enterprise by software applications executing in the other systems/nodes of computing infrastructure 130. Each data store may be implemented as a corresponding database server using relational database technologies and accordingly provide storage and retrieval of data using structured queries such as SQL (Structured Query Language). Alternatively, each data store may be implemented as a corresponding file server providing storage and retrieval of data in the form of files organized as one or more directories, as is well known in the relevant arts.

Some of the nodes 160 may be implemented as corresponding server systems. Each server system represents a server, such as a web/application server, constituted of appropriate hardware executing software applications capable of performing tasks requested by end-user systems 110. A server system receives a user request from an end-user system and performs the tasks requested in the user request. A server system may use data stored internally (for example, in a non-volatile storage/hard disk within the server system), external data (e.g., maintained in a data store) and/or data received from external sources (e.g., received from a user) in performing the requested tasks. The server system then sends the result of performance of the tasks to the requesting end-user system (one of 110) as a corresponding response to the user request. The results may be accompanied by specific user interfaces (e.g., web pages) for displaying the results to a requesting user.

Each of end-user systems 110 represents a system such as a personal computer, workstation, mobile device, computing tablet etc., used by users to generate (user) requests directed to software applications executing in server systems of computing infrastructure 130. A user request refers to a specific technical request (for example, Universal Resource Locator (URL) call) sent to a server system from an external system (here, end-user system) over Internet 120, typically in response to a user interaction at end-user systems 110. The user requests may be generated by users using appropriate user interfaces (e.g., web pages provided by an application executing in a node, a native user interface provided by a portion of an application downloaded from a node, etc.).

In general, an end-user system requests a software application for performing desired tasks and receives the corresponding responses (e.g., web pages) containing the results of performance of the requested tasks. The web pages/responses may then be presented to a user by a client application such as the browser. Each user request is sent in the form of an IP packet directed to the desired system or software application, with the IP packet including data identifying the desired tasks in the payload portion.

In one embodiment, computing infrastructure 130 is used to manage (large) construction and engineering projects. One requirement in such an environment is the seamless collaboration between the different organizations participating in a project. Specifically, document review in a construction project is a long and complicated process involving lots of actions with many back and forth interactions (using end-user systems 110) between the participating organizations.

Accordingly, nodes 160 (in particular, the server systems) may host a management software that assists project teams to keep document reviews structured and simple. A user (using one of end-user systems 110) is enabled to create a workflow using a predefined template and specify the expected date by which each action (hereinafter referred to as a “workflow step”) in the workflow should be closed/completed. The details of the workflows may be maintained in nodes 160 (in particular, data stores). The management software may then assist the project team to monitor the progress of the workflow, and correspondingly the document review. An example of such a management software widely used in construction projects is Aconex Construction Management available from Oracle Corporation, the assignee of the instant application.

As noted in the Background Section, delays are commonly encountered in workflows and it may be desirable to predict such delays pro-actively based on historical data containing the details of completed workflows and associated actual delays.

Predictor tool 150 represents a system that predicts delays in workflows based on machine learning (ML) model(s). The ML models may use ML approaches such as KNN (K Nearest Neighbor), Decision Tree, etc. for the correlation of historical data and the prediction of delays. Broadly, an ML model uses various features extracted from a current workflow and previous workflows closed by the reviewers (historical data) to make a prediction of the delay that may occur in each workflow step of the current workflow. Such prediction may assist the project teams to proactively plan their schedule accounting for the predicted delay.

Supervised learning ML models, commonly used to deal with the substantial volumes of generated data, necessitate continuous refinement to effectively accommodate the dynamic shifts in data patterns. In particular, the time taken for each workflow step in the review process and the delay may vary as the project team progresses through different construction phases. As such, the ML model may be required to constantly adapt to these changes. For example, a ML model trained with data from the initial stages of construction would not perform well in the later stages due to changes in the timelines and requirements at different stages of construction.

Data drift in machine learning refers to the phenomenon where the statistical properties of the input data used for training a machine learning model change over time. Such a change can occur due to various reasons such as shifts in the distribution of the data, changes in feature relationships, or alterations in the data-generating process. Data drift can significantly impact the performance of machine learning models, as they may become less accurate or even obsolete when deployed in dynamic, real-world environments.

Predictor tool 150, extended according to several aspects of the present disclosure, provides an ML model based prediction of delays in workflows while overcoming some of the challenges noted above. Though shown implemented as a separate system, in alternative embodiments, predictor tool 150 may be implemented on one of nodes 160 in computing infrastructure 130 or as a system external (connected to Internet 120) to computing infrastructure 130. The manner in which predictor tool 150 provides ML model based prediction of delays is described below with examples.

### 3. Providing Machine Learning Model Based Prediction of Delays in Workflows

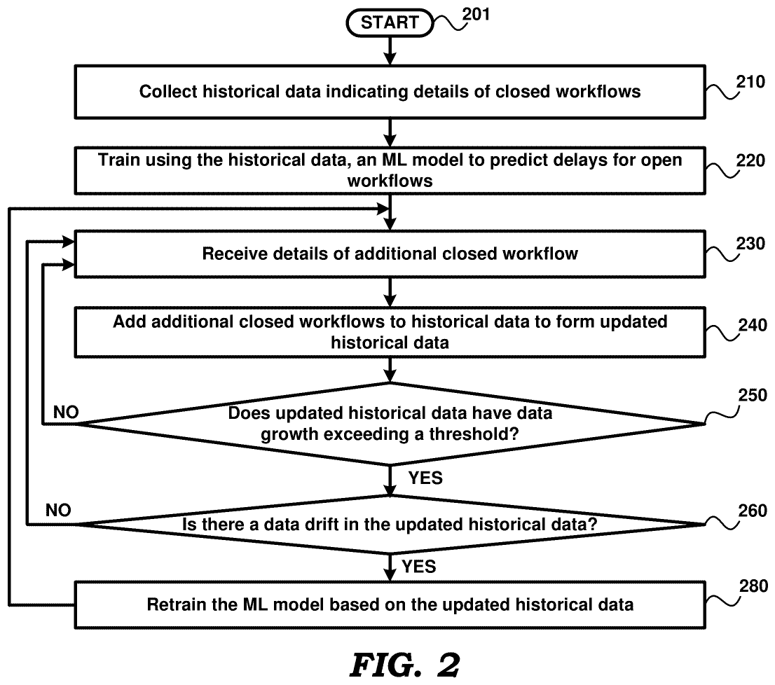

FIG. 2 is a flow chart illustrating the manner in which a machine learning (ML) model based prediction of delays in workflows is provided according to aspects of the present disclosure. The flowchart is described with respect to the systems of FIG. 1 in particular predictor tool 150, merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 210.

In step 210, predictor tool 150 collects historical data indicating details of closed workflows. A closed workflow typically refers to a workflow that is determined to be completed, that is, all the necessary workflow steps in the workflow have been performed. A workflow may also be marked as completed due to reasons such as the pending actions in the workflow are no longer required to be performed, there has been considerable delay for the workflow, etc.

Each workflow step in a closed workflow is associated with a corresponding actual delay indicating the difference between a total number of days in which the workflow step was completed and an expected/planned time of completion. The details of the closed workflows such as the workflow steps, expected times, actual delays, etc. may be collected from nodes 160 hosting the management software.

In step 220, predictor tool 150 trains using the historical data (the details of the closed workflows), an ML model to predict delays for open workflows. An open workflow refers to a workflow that is currently in operation, that is, there are actions in the workflow that are pending to be performed. Training the ML model may entail extracting one or more features (such as organization performance, organization load, etc. explained in detail in the below sections) from the details of the closed workflows and providing the features as inputs to an ML approach. Such a trained ML model may thereafter be used to predict the delays for open workflows, as will be readily apparent to one skilled in the relevant arts.

In step 230, predictor tool 150 receives details of additional closed workflow (from nodes 160). The additional closed workflows may include workflows created based on new templates, workflows that have been marked closed after collecting (in step 210), workflows that have been modified and completed, etc. In step 240, predictor tool 150 adds additional closed workflows to historical data to form updated historical data.

In step 250, predictor tool 150 checks whether the updated historical data has a data growth exceeding a threshold. The data growth represents the quantitative change in the historical data. The data growth may be calculated in comparison to the historical data (collected in step 210), for example, as (current data size-previous data size)/previous data size, where the current data size and the previous data size are amounts of updated historical data and historical data respectively.

Any convenient threshold such as 20%, 25%, etc. may be chosen as the basis for indicating the data growth. If the data growth does not exceed the threshold, control passes to step 230 where the subsequent steps are performed at a future time instance. If the data growth exceeds the threshold, control passes to step 260.

In step 260, predictor tool 150 determines whether there exists a data drift in the updated historical data in comparison to the historical data. The existence of a data drift indicates that there has been qualitative change in the historical data, and that the ML model trained on the historical data may no longer be able to provide accurate prediction of delays for open workflows. Data drift can be identified according to various statistical approaches well known in the relevant arts.

According to an aspect, predictor tool 150 employs an ensemble (containing at least two) of statistical approaches (such as Population Stability Index (PSI) test, a binary classification test, etc.) to identify a corresponding shift in data of the updated historical data as a respective result. Predictor tool 150 then detects the existence of data drift based on the respective results provided by the ensemble of statistical approaches.

If the data drift is not detected, control passes to step 230 where the subsequent steps are performed at a future time instance. Thus, it may be appreciated that if the data growth does not exceed the threshold or if the data growth exceeds the threshold but a data drift is determined to not exist, predictor tool 150 continues to use the ML model trained in step 220. If the data drift is detected, control passes to step 280.

In step 280, predictor tool 150 retrains the ML model based on the updated historical data, the updated ML model being thereafter used to predict delays for open workflows. In other words, retraining of the ML model is performed only if the updated historical data is quantitatively (data growth) and qualitatively (data drift) different from that in the historical data.

Retraining of the ML model may entail training a new ML model (using the same or different ML approach from the one previously used in step 220) with the details of the collected and additional closed workflows being provided as inputs, and replacing the previous ML model with the new ML model. However, in alternative embodiments, retraining may entail updating the existing ML model (of step 220) with the details of the additional closed workflows, as will be apparent to one skilled in the relevant arts.

After retraining, control passes to step 230 where the subsequent steps are performed at a future time instance. According to an aspect, the steps of 230 through 280 may be performed at different time instances to keep the ML model adapted to changes in the historical data such that delays for open workflows continue to be predicted accurately. It may be appreciated that during such iterative operation, the updated historical data obtained at any given time instance is compared (both of data growth and data drift) to the updated historical data at a previous time instance at which the ML model was retrained (instead of the historical data of step 210). Furthermore, in parallel to steps 230 through 280, the trained/previously retrained ML model is operative to predict delays in workflows.

Thus, predictor tool 150 provides ML model based prediction of delays in workflows. In particular, identifying data drift and retraining the ML model with newer data helps maintain the performance and reliability of the ML model with the changing data distribution. The manner in which predictor tool 150 provides several aspects of the present disclosure according to the steps of FIG. 2 is described below with examples.

### 4. Illustrative Example

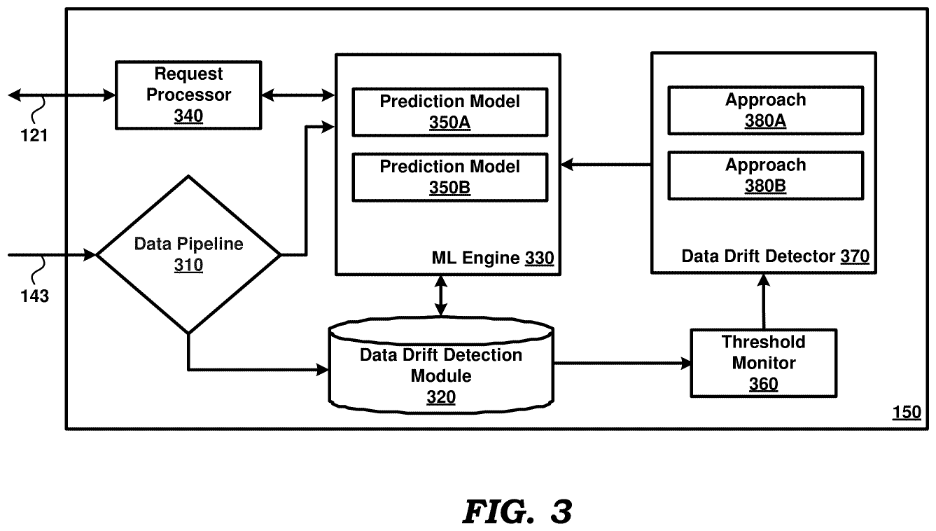

FIGS. 3, 4A-4C and 5 together illustrate the manner in which ML model based prediction of delays in workflows is provided in one embodiment. Each of the Figures is described in detail below.

FIG. 3 is a block diagram depicting an implementation of a predictor tool (150) in one embodiment. The block diagram is shown containing data pipeline 310, operational data repository (ODR) 320, machine learning (ML) engine 330 (in turn, shown containing prediction model 350A and 350B), request processor 340, threshold monitor 360 and data drift detector 370 (in turn, shown containing statistical approach 380A and 280B). Each of the blocks is described in detail below.

Data pipeline 310 receives (via path 143) details of open and closed workflows from nodes 160 hosting the management software noted above. The details may be received as part of collecting the historical data or as part of receiving the additional closed workflows. Data pipeline 310 may then perform any desired pre-processing actions such as normalization, sampling, scaling, etc. to the received data prior to storing the pre-processed data in ODR 320.

ODR 320 represents a data store that maintains the details of pre-processed open and closed workflows. In the description herein, the term “workflow data” refers to the details of both open and closed workflows, while the term “historical data” refers to the details of only the closed workflows. ODR 320 may maintain the historical data associated with different time instances so as to enable retrieval of the updated historical data at the different time instance. Though shown internal to predictor tool 150, in alternative embodiments, predictor tool 150 may be implemented external to predictor tool 150, for example, in one or more of nodes 160. Data pipeline 310 also forwards the historical data to ML engine 330.

ML engine 330 generates and maintains various machine learning models that correlate the data received from data pipeline 310. The models may be generated using any machine learning or deep learning approaches, either supervised or unsupervised. Examples of machine learning (ML) approaches are KNN (K Nearest Neighbor), Decision Tree, etc., while deep learning approaches are Multilayer Perceptron (MLP), Convolutional Neural Networks (CNN), Long short-term memory networks (LSTM) etc. Various other non-supervised or supervised machine learning approaches can be employed, as will be apparent to skilled practitioners, by reading the disclosure provided herein.

Each of prediction models 350A and 350B correlates the details of the workflow steps in the closed workflows to corresponding delays. In the following disclosure, it is assumed that prediction models 350A and 350B represent models generated based on (updated) historical data collected at different time instances. Each prediction model implementing a corresponding ML approach is trained using the historical data stored in ODR 320. After training, each prediction model is operative to predict delays for open workflows. The description is continued assuming that prediction model 350A is the most recently trained/retrained.

Request processor 340 receives (via path 121) requests for delays in open workflows from end-user systems 110, performs any required pre-processing (those noted above) and forwards the details of the pre-processed request as inputs to the prediction model recently trained/retrained (here, 350A). The prediction model (350A) predicts a delay for the received open workflows and send the predicted delays to request processor 340, which in turn forwards (via path 121) the delays as corresponding responses to the received requests.

Thus, predictor tool 150 provides a machine learning (ML) model based prediction of delays in workflows. As noted above, aspects of the present disclosure are directed to determining the changes to the historical data, and retraining the ML model if needed, as described below with examples.

### 5. Retraining the Machine Learning Model

Threshold monitor 360 determines whether there has been significant data growth of the historical data stored in ODR 320. Threshold monitor 360 may perform the check periodically (say, every 15 days) or when new additional closed workflows are received and stored in ODR 320. In one embodiment, the data growth percentage is calculated using the following formula:

Data Growth %=(Incremental data size/Previous retraining data size)*100

Where,

Incremental data size=Current retraining data size−Previous retraining data size

It may be noted that the retraining data sizes noted above are the same as the amount of updated historical data. If the Data Growth % is greater than a specified threshold percentage (usually 20%), threshold monitor 360 triggers data drift detector 370 for checking whether data drift exists. Alternatively, threshold monitor 360 does not perform any further action, and predictor tool 150 continues to use prediction model 350A for the prediction of delays in open workflows, since there is no significant amount of new data for the retraining to be meaningful or effective in improving the performance of the ML models.

Data drift detector 370, upon receiving a trigger from threshold monitor 360, performs an ensemble of statistical approaches to determine the shift in data between a current historical data and a previous historical data (specifically at a time instance at which the retraining was previously performed).

Each of statistical approaches 380A-380B represents a statistical approach used to determine data drift. In one embodiment, statistical approaches 380A-380B respectfully represent Population Stability Index (PSI) Test and Binary Classification Test which are briefly described below.

### Population Stability Index Test

The Population Stability Index (PSI) is a widely used statistic that measures how much a variable has shifted over time or between two different samples of a population. PSI is calculated by dividing the data into bins or segments and comparing the frequency or probability distribution of the variable in each bin. The process of calculating PSI for 2 sets of samples from previous retraining data (A) and incremental data (B) involves the following steps:
1. Data binning: Dividing the data range into k bins or segments based on an equal-width binning strategy.
2. Calculating bin probabilities: For each bin, the probability of the variable falling within that range is calculated. This can be done by dividing the number of observations in the bin by the total number of observations in the dataset. The probabilities are calculated for both A and B at each bin.
3. Calculating PSI: The PSI is calculated using the formula:

$$PSI = {\sum }_{i = 1}^{k} ( ( {a}_{i} - {b}_{i} ) \times ln ( \frac{{a}_{i}}{{b}_{i}} ) )$$

where aᵢ and bᵢ represent the probability of a variable occurring in the i^{th} bin.

A high PSI value indicates a significant change in the distribution of a variable, which may suggest data drift. The system uses the following interpretation of the PSI values:
PSI<0.1: No significant population change
PSI<0.2: Moderate population change
PSI>=0.2: Significant population change

Data drift detector 370 runs the PSI test for all the numerical features and get a count (PSI_high) of the features that have a significant population change. If more than 35% of the features have a PSI value, the PSI test has detected data drift. It should be noted that the value of 35% was empirically determined through a series of experiments.

$$PSI\_result = ( PSI\_high / total\_features ) > 0.35$$

### Binary Classification Test

The Binary classification test works by training a binary classification model to discriminate between data from previous retrained and incremental distributions. The model is trained to predict a target value of 0 for the previously retrained dataset and a target value of 1 for the incremental dataset. The performance of the data drift classifier is related to the difference between the two datasets, with a marked difference leading to an easy classification and a final AUC (“area under curve”) close to 1. Similar datasets will lead to poor data drift classifier performance and a final AUC close to 0.5.

Before training the classifier, data drift detector 370 applies the Synthetic Minority Over-sampling Technique (SMOTE) to address the dataset's imbalance. This is particularly crucial as the incremental data, typically constituting only 20% of the size of the previously retrained dataset (due to data growth threshold), may result in an uneven distribution. SMOTE helps ensure a more balanced representation, enhancing the model's ability to generalize across different classes. Such an approach works by creating new synthetic minority class examples based on the k-nearest neighbors of the underrepresented class samples.

Data drift detector 370 then splits the dataset in train and validation splits in the ratio 80:20. The logistic regression classifier is used to train a model on the train split of the dataset and calculate the ROC AUC score of the model on the validation split. If the AUC score is greater than 0.91, the Binary classification test has detected data drift. The hyperparameter value of 0.91 has been determined through empirical experimentation. The hyperparameter value can be fine-tuned to adjust the retraining frequency according to the specific use case.

$$Binary\_classification \_result = AUC Score of Logistic Regression \\ \\ classification model > 0.91$$

Based on the results of the 2 tests/approaches (380A/380B), data drift detector 370 may determine that retraining of the ML model is required. In one embodiment, data drift detector triggers retraining if any of the two results (PSI_result and Binary_classification_result) indicates data drift. According to an aspect, data drift detector 370 determine that retraining is required only when both the results (PSI_result and Binary_classification_result) indicate data drift. Upon determining that retraining is required, data drift detector 370 sends a retraining indication to ML engine 330, which in turn performs retraining.

In one embodiment, ML engine 330 trains a new prediction model (350B) on the combined dataset of previous retraining data (A) and incremental data (B) and then replaces the existing model (350A) with the newly retrained model (350B). As such prediction model 350B becomes the most recently trained/retrained ML model, and is thereafter used by request processor 340 to predict the delays in open workflows.

The description is continued with sample data used in the generation and prediction of machine learning models.

### 6. Sample Data

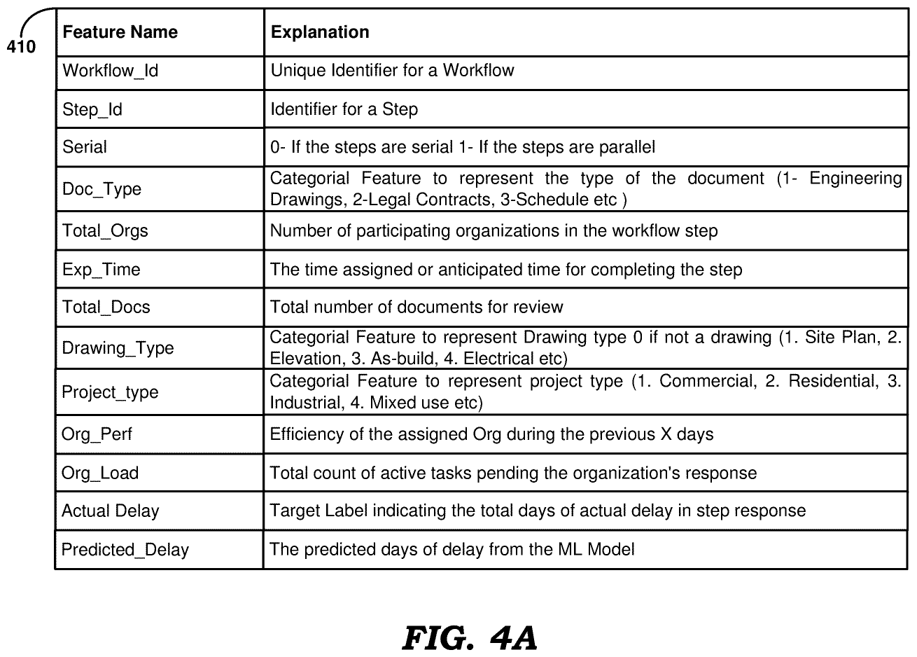

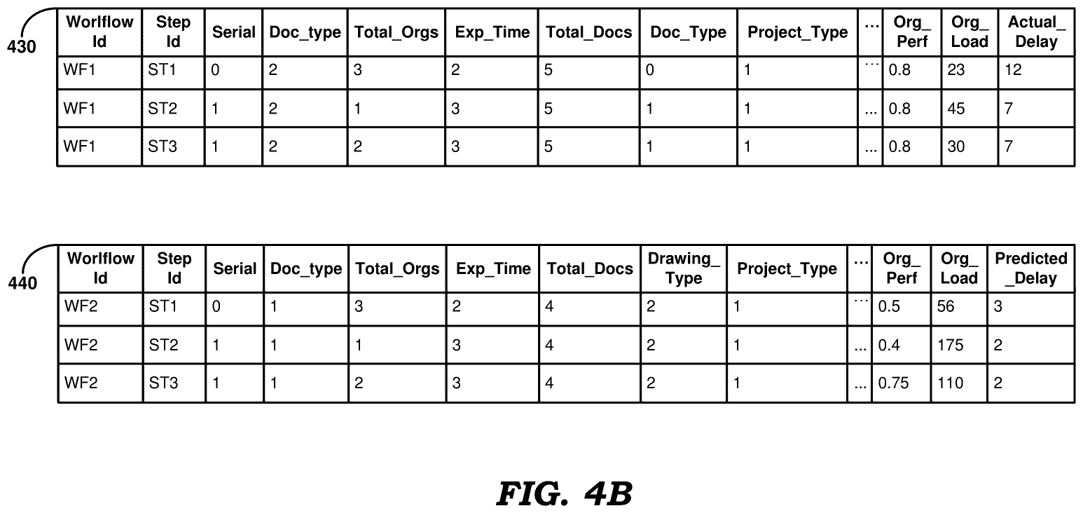

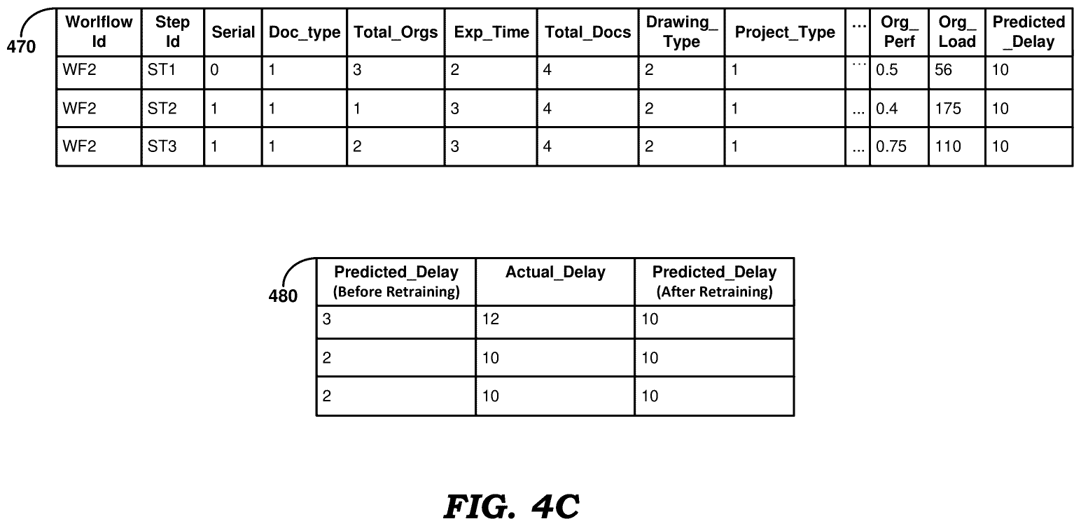

FIG. 4A depicts a portion of the features used to train ML models (350A/350B) operative to predict delays in workflows in one embodiment. Table 410 depicts the feature names and a corresponding description of the features. Specifically, Org_Perf (organization performance) indicates an efficiency of an assigned organization in a previous number (X) of days, while Org_Load (organization load) indicates a total count of active tasks pending a response from the assigned organization.

FIG. 4B depicts the details of the open and closed workflows in one embodiment. Specifically, table 430 depicts the details of a closed workflow (WF1) that is provided as training data to prediction models 350A/350B. Each row in table 430 depicts the details of a corresponding workflow step (ST1, ST2, etc.) in the closed workflow. It may be observed that table 430 includes an actual delay (in number of days), which serves as the target label for training the model. In addition, feature Org_Perf is shown having an example range between 80 and 90, while feature Org_Load is shown having an example range between 20 and 45.

Table 440 depicts the details of an open workflow (WF2) for which the delay is desired to be predicted. Each row in table 440 depicts the details of a corresponding workflow step (ST1, ST2, etc.) in the open workflow. The Predicted_Delay column indicates the delay in days as predicted by models 350A/350B. It may be observed that there are significant changes (here, a change in the magnitude of values) in features such as Org_Perf and Org_Load. Such changes may arise due to numerous factors in the construction process, for example, supply chain disruptions, labor availability, weather, project complexity etc. Such changes, which are not accounted for by a current ML model (350A/350B), could lead to extrapolation errors when predicting delays based on other features, potentially affecting the accuracy of the results.

It may be appreciated the following multiple factors (in addition to magnitude noted above) may contribute to the conclusion of data drift:
Concept Drift: Refers to the changes in the underlying relationship between the input features and target variable
Temporal Drift: Involves change in the data patterns over time, often seen in time series data.
Covariate Shift: Occurs when the distribution of the input features changes but the relationship between the input features and the target variable remains the same.

Accordingly, it may be crucial to proactively capture these drifts in the data and subsequently train the model on these new data points. Such retraining ensures that the ML model learns and adapts to the evolving data pattern

FIG. 4C depicts the delays predicted before and after retraining of ML model in one embodiment. Table 470 depicts the details of the open workflow WF2 same as in table 440, but with the predicted delay determined after retraining of the ML model (350A/350B).

Table 480 provides a comparison of the predicted delays. In particular, column “Predicted Delay (Before Retraining)” indicates the delay in days as predicted by ML model (350A/350B) before retraining, while column “Predicted_Delay (After Retraining)” indicates delay after retraining which are improved prediction results compared to those obtained prior to retraining. The column “Actual_Delay” indicates the actual delay observed after the workflow was closed. It may be observed that the delays predicted after retraining are closer/accurate to the actual delay values.

Thus, aspects of the present disclosure are used to build a system having the following capabilities—(1) Employing a synergistic ensemble of statistical methods, strategically leveraging their individual strengths and weaknesses to enhance the overall effectiveness of the Machine Learning system; (2) Automatic retraining is triggered upon the fulfilment of adequate data and the occurrence of data drift conditions; and (3) A newly developed model is used to predict construction workflow delays with improved precision and reliability, empowering organizations to proactively manage and optimize their operations.

It may be noted that the features of the present disclosure are described above with respect to construction and engineering projects, the features may be implemented in any other industry that uses workflows for project management and there is a need to predict delays in such workflows, as will be apparent to one skilled in the arts by reading the disclosure herein.

It should be further appreciated that the features described above can be implemented in various embodiments as a desired combination of one or more of hardware, software, and firmware. The description is continued with respect to an embodiment in which various features are operative when the software instructions described above are executed.

### 7. Digital Processing System

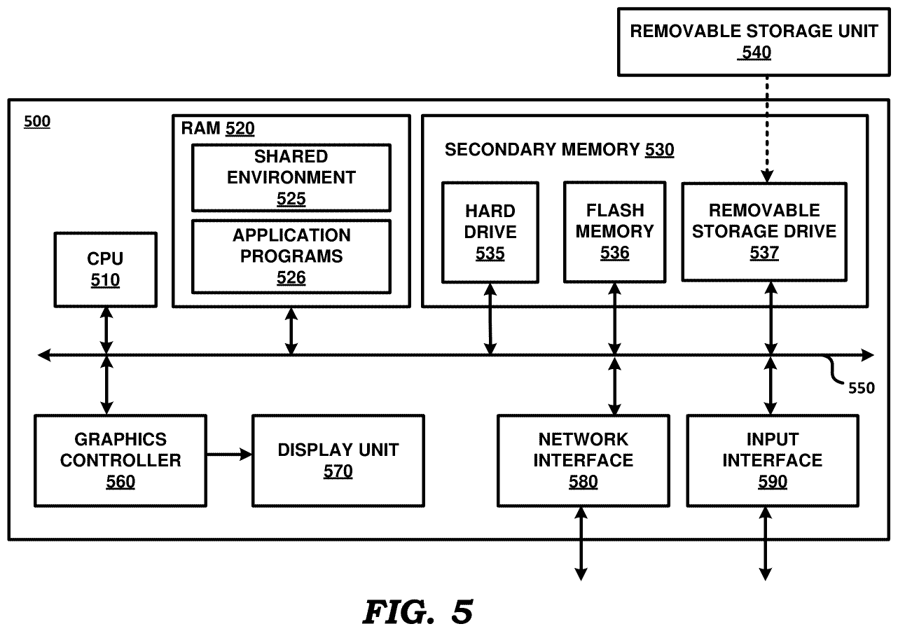

FIG. 5 is a block diagram illustrating the details of a digital processing system in which various aspects of the present disclosure are operative by execution of appropriate executable modules. Digital processing system 500 may correspond to predictor tool 150 or any system implementing predictor tool 150.

Digital processing system 500 may contain one or more processors such as a central processing unit (CPU) 510, random access memory (RAM) 520, secondary memory 530, graphics controller 560, display unit 570, network interface 580, and input interface 590. All the components except display unit 570 may communicate with each other over communication path 550, which may contain several buses as is well known in the relevant arts. The components of FIG. 5 are described below in further detail.

CPU 510 may execute instructions stored in RAM 520 to provide several features of the present disclosure. CPU 510 may contain multiple processing units, with each processing unit potentially being designed for a specific task. Alternatively, CPU 510 may contain only a single general-purpose processing unit.

RAM 520 may receive instructions from secondary memory 530 using communication path 550. RAM 520 is shown currently containing software instructions constituting shared environment 525 and/or other user programs 526 (such as other applications, DBMS, etc.). In addition to shared environment 525, RAM 520 may contain other software programs such as device drivers, virtual machines, etc., which provide a (common) run time environment for execution of other/user programs.

Graphics controller 560 generates display signals (e.g., in RGB format) to display unit 570 based on data/instructions received from CPU 510. Display unit 570 contains a display screen to display the images defined by the display signals. Input interface 590 may correspond to a keyboard and a pointing device (e.g., touch-pad, mouse) and may be used to provide inputs. Network interface 580 provides connectivity to a network (e.g., using Internet Protocol), and may be used to communicate with other systems connected to the networks.

Secondary memory 530 may contain hard drive 535, flash memory 536, and removable storage drive 537. Secondary memory 530 may store the data (e.g., data portions shown in FIGS. 4A-4C) and software instructions (e.g., for performing the actions of FIGS. 2, for implementing the blocks of FIG. 3), which enable digital processing system 500 to provide several features in accordance with the present disclosure. The code/instructions stored in secondary memory 530 may either be copied to RAM 520 prior to execution by CPU 510 for higher execution speeds, or may be directly executed by CPU 510.

Some or all of the data and instructions may be provided on removable storage unit 540, and the data and instructions may be read and provided by removable storage drive 537 to CPU 510. Removable storage unit 540 may be implemented using medium and storage format compatible with removable storage drive 537 such that removable storage drive 537 can read the data and instructions. Thus, removable storage unit 540 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 540 or hard disk installed in hard drive 535. These computer program products are means for providing software to digital processing system 500. CPU 510 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 530. Volatile media includes dynamic memory, such as RAM 520. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 550. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 8. CONCLUSION

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method for providing machine learning (ML) model based prediction of delays in workflows, the method comprising:
collecting a historical data indicating details of a plurality of closed workflows;
training an ML model based on said plurality of closed workflows, said ML model thereafter operable to predict delays for open workflows;
receiving, after said training, details of an additional set of closed workflows;
adding said details of said additional set of closed workflows to said historical data to form an updated historical data;
checking whether said updated historical data has a data growth exceeding a threshold, said data growth being calculated in comparison to said historical data;
if said data growth exceeds said threshold, determining whether there exists a data drift in said updated historical data in comparison to said historical data; and
if said data drift exists, retraining said ML model based on said updated historical data, wherein said retrained ML model is thereafter operable to predict delays for open workflows.

2. The method of claim 1, wherein said checking and said determining are performed at a first time instance, said method further comprising:
if a first data growth calculated at said first time instance does not exceed said threshold or if said first data growth exceeds said threshold but a first data drift is determined to not exist at said first time instance, continuing to use said ML model trained or retrained at a previous time instance prior to said first time instance.

3. The method of claim 2, wherein said retraining comprises:
training a new ML model based on said plurality of closed workflows and said additional set of closed workflows; and
replacing said ML model with said new ML model such that said new ML model is thereafter operable to predict delays for open workflows,
wherein said receiving and said adding, said checking, said determining and said retraining are performed at a plurality of time instances including said previous time instance to keep said ML model adapted to changes in said historical data such that delays for open workflows continue to be predicted accurately,

4. The method of claim 2, wherein said checking at said first time instance comprises:
calculating said first data growth as (current data size-previous data size)/previous data size,
wherein said current data size and said previous data size are amounts of said updated historical data at said first time instance and said previous time instance respectively.

5. The method of claim 4, wherein said determining said first data drift at said first time instance comprises:
employing a plurality of statistical approaches to identify a corresponding shift in data of said updated historical data at said first time instance in comparison to said updated historical data at said previous time instance, each statistical approach providing a respective result indicating said corresponding shift in data; and
detecting said first data drift based on said respective results provided by said plurality of statistical approaches.

6. The method of claim 5, wherein said plurality of statistical approaches comprises a Population Stability Index (PSI) test and a binary classification test, wherein said detecting detects that said first data drift exists only if all of said respective results indicates said corresponding shift in data.

7. The method of claim 1, wherein each workflow comprises one or more workflow steps, wherein details of a workflow step in a closed workflow includes a flag to indicate whether said workflow step is to be performed in serial or in parallel, a type of the document to be reviewed in said workflow step, a total number of organizations involved in said workflow step, an expected time assigned for completion of said workflow step, an organization performance indicating an efficiency of an assigned organization in a previous number of days, an organization load indicating a total count of active tasks pending a response from said assigned organization and an actual delay indicating the difference between a total number of days in which said workflow step was completed and said expected time.

8. A non-transitory machine-readable medium storing one or more sequences of instructions for providing machine learning (ML) model based prediction of delays in workflows, wherein execution of said one or more instructions by one or more processors contained in a digital processing system cause said digital processing system to perform the actions of:
collecting a historical data indicating details of a plurality of closed workflows;
training an ML model based on said plurality of closed workflows, said ML model thereafter operable to predict delays for open workflows;
receiving, after said training, details of an additional set of closed workflows;
adding said details of said additional set of closed workflows to said historical data to form an updated historical data;
checking whether said updated historical data has a data growth exceeding a threshold, said data growth being calculated in comparison to said historical data;
if said data growth exceeds said threshold, determining whether there exists a data drift in said updated historical data in comparison to said historical data; and
if said data drift exists, retraining said ML model based on said updated historical data, wherein said retrained ML model is thereafter operable to predict delays for open workflows.

9. The non-transitory machine-readable medium of claim 8, wherein said checking and said determining are performed at a first time instance, further comprising one or more instructions for:
if a first data growth calculated at said first time instance does not exceed said threshold or if said first data growth exceeds said threshold but a first data drift is determined to not exist at said first time instance, continuing to use said ML model trained or retrained at a previous time instance prior to said first time instance.

10. The non-transitory machine-readable medium of claim 9, wherein said retraining comprises one more instructions for:
training a new ML model based on said plurality of closed workflows and said additional set of closed workflows; and
replacing said ML model with said new ML model such that said new ML model is thereafter operable to predict delays for open workflows,
wherein said receiving and said adding, said checking, said determining and said retraining are performed at a plurality of time instances including said previous time instance to keep said ML model adapted to changes in said historical data such that delays for open workflows continue to be predicted accurately.

11. The non-transitory machine-readable medium of claim 9, wherein said checking at said first time instance comprises one or more instructions for:
calculating said first data growth as (current data size-previous data size)/previous data size,
wherein said current data size and said previous data size are amounts of said updated historical data at said first time instance and said previous time instance respectively.

12. The non-transitory machine-readable medium of claim 11, wherein said determining said first data drift at said first time instance comprises one or more instructions for:
employing a plurality of statistical approaches to identify a corresponding shift in data of said updated historical data at said first time instance in comparison to said updated historical data at said previous time instance, each statistical approach providing a respective result indicating said corresponding shift in data; and
detecting said first data drift based on said respective results provided by said plurality of statistical approaches.

13. The non-transitory machine-readable medium of claim 12, wherein said plurality of statistical approaches comprises a Population Stability Index (PSI) test and a binary classification test, wherein said detecting detects that said first data drift exists only if all of said respective results indicates said corresponding shift in data.

14. The non-transitory machine-readable medium of claim 8, wherein each workflow comprises one or more workflow steps, wherein details of a workflow step in a closed workflow includes a flag to indicate whether said workflow step is to be performed in serial or in parallel, a type of the document to be reviewed in said workflow step, a total number of organizations involved in said workflow step, an expected time assigned for completion of said workflow step, an organization performance indicating an efficiency of an assigned organization in a previous number of days, an organization load indicating a total count of active tasks pending a response from said assigned organization and an actual delay indicating the difference between a total number of days in which said workflow step was completed and said expected time.

15. A digital processing system comprising:
a random access memory (RAM) to store instructions for providing machine learning (ML) model based prediction of delays in workflows; and
one or more processors to retrieve and execute the instructions, wherein execution of the instructions causes the digital processing system to perform the actions of:
collecting a historical data indicating details of a plurality of closed workflows;
training an ML model based on said plurality of closed workflows, said ML model thereafter operable to predict delays for open workflows;
receiving, after said training, details of an additional set of closed workflows;
adding said details of said additional set of closed workflows to said historical data to form an updated historical data;
checking whether said updated historical data has a data growth exceeding a threshold, said data growth being calculated in comparison to said historical data;
if said data growth exceeds said threshold, determining whether there exists a data drift in said updated historical data in comparison to said historical data; and
if said data drift exists, retraining said ML model based on said updated historical data, wherein said retrained ML model is thereafter operable to predict delays for open workflows.

16. The digital processing system of claim 15, wherein said checking and said determining are performed at a first time instance, said digital processing system further performing the actions of:
if a first data growth calculated at said first time instance does not exceed said threshold or if said first data growth exceeds said threshold but a first data drift is determined to not exist at said first time instance, continuing to use said ML model trained or retrained at a previous time instance prior to said first time instance.

17. The digital processing system of claim 16, wherein for said retraining, said digital processing system performs the actions of:
training a new ML model based on said plurality of closed workflows and said additional set of closed workflows; and
replacing said ML model with said new ML model such that said new ML model is thereafter operable to predict delays for open workflows,
wherein said receiving and said adding, said checking, said determining and said retraining are performed at a plurality of time instances including said previous time instance to keep said ML model adapted to changes in said historical data such that delays for open workflows continue to be predicted accurately.

18. The digital processing system of claim 2, wherein for said checking at said first time instance, said digital processing system performs the actions of:
calculating said first data growth as (current data size-previous data size)/previous data size,
wherein said current data size and said previous data size are amounts of said updated historical data at said first time instance and said previous time instance respectively.

19. The digital processing system of claim 18, wherein for said determining said first data drift at said first time instance, said digital processing system performs the actions of:
employing a plurality of statistical approaches to identify a corresponding shift in data of said updated historical data at said first time instance in comparison to said updated historical data at said previous time instance, each statistical approach providing a respective result indicating said corresponding shift in data; and
detecting said first data drift based on said respective results provided by said plurality of statistical approaches.

20. The digital processing system of claim 19, wherein said plurality of statistical approaches comprises a Population Stability Index (PSI) test and a binary classification test, wherein said digital processing system detects that said first data drift exists only if all of said respective results indicates said corresponding shift in data.
